(19) United States
(12) Patent Application Publication
(10) Pub. No.: US 2014/0265059 A1
(43) Pub. Date: Sep. 18, 2014

(54) APPARATUS FOR MANUFACTURING AND PROCESSING FILMS HAVING STRIPS OF INCREASED THICKNESS

(71) Applicant: Davis-Standard, LLC, Pawcatuck, CT (US)

(72) Inventors: Hassan Helmy, Branchburg, NJ (US); Robert F. Moeller, Baldwinsville, NY (US); John P. Christiano, Old Lyme, CT (US); Daniel F. Hould, Oswego, NY (US)

(73) Assignee: Davis-Standard, LLC, Pawcatuck, CT (US)

(21) Appl. No.: 14/213,072

(22) Filed: Mar. 14, 2014

Related U.S. Application Data
(63) Continuation-in-part of application No. 14/212,840, filed on Mar. 14, 2014.
Application No. 14/212,840 is a continuation-in-part of application No. 14/212,289, filed on Mar. 14, 2014.
Application No. 14/212,289 is a continuation-in-part of application No. 14/210,531, filed on Mar. 14, 2014.
(60) Provisional application No. 61/932,519, filed on Jan. 28, 2014.
(60) Provisional application No. 61/788,776, filed on Mar. 15, 2013.

(51) Int. Cl. B29D 7/01

(52) U.S. Cl. CPC B29D 7/01
USPC 264/555; 425/72.1

(57) ABSTRACT

A device for producing film includes a die defining a die outlet through which molten polymer is extruded. The polymer is suitable for producing one of a pre-stretch film and a conventional stretch film. The device includes a film producing device spaced apart from the die. One or more coolant supplies are positioned proximate the film producing device for directing a stream of coolant onto the molten polymer positioned on the film producing device and/or between the die and film producing device, for producing film having strips of increased thickness.

### CROSS REFERENCE TO RELATED APPLICATIONS

This application is a continuation-in-part of U.S. patent application Ser. No. 14/210,531, entitled “Apparatus for Manufacturing and Processing Films,” and filed Mar. 14, 2014, the subject matter of which is incorporated herein by reference in its entirety. This application is a continuation-in-part of U.S. patent application Ser. No. 14/212,289, entitled “Apparatus for Manufacturing and Processing Pre-Stretch Films Having Strips of Increased Thickness,” and filed Mar. 14, 2014, the subject matter of which is incorporated herein by reference in its entirety. This application is a continuation-in-part of U.S. patent application Ser. No. 14/212,840, entitled “Apparatus for Manufacturing and Processing Pre-Stretch Films Having Strips of Increased Thickness,” and filed Mar. 14, 2014, the subject matter of which is incorporated herein by reference in its entirety. This application claims priority to U.S. Provisional Patent Application Ser. No. 61/788,776, entitled “Apparatus for Manufacturing and Processing Films,” and filed Mar. 15, 2013, the subject matter of which is incorporated herein by reference in its entirety. This application claims priority to U.S. Provisional Patent Application Ser. No. 61/932,519, entitled “Apparatus for Manufacturing and Processing Films Having Strips of Increased Thickness,” and filed Jan. 28, 2014, the subject matter of which is incorporated herein by reference in its entirety.

### FIELD OF THE INVENTION

The present invention relates to an apparatus and method for manufacturing films used for both machine film and hand film for packaging applications and in particular to an apparatus for manufacturing and processing films having one, two or more strips of increased thickness. In particular, the apparatus and method is directed to conventional stretch films manufactured in-process and for pre-stretch films for off-line processing (e.g., machine direction stretching). The strips of increased thickness are generated by: 1) selectively cooling portions of a molten polymer material proximate a die outlet by directing a stream of coolant onto the molten polymer as the polymer exits the die outlet; 2) selectively cooling portions of a molten polymer material while the molten material is on the cooling drum; 3) forming and cooling strips of increased thickness by selectively controlling flow of the molten polymer material through the die; 4) forming and cooling strips of increased thickness by forming temporary depressions or permanent grooves in a die lip and/or 5) by forming grooves in a casting drum.

### BACKGROUND OF THE INVENTION

Films, such as polymer films, can be produced by several different processes including blown film and chill roll casting. In the blown film method, the melt is extruded through an annular die to form a bubble expanded with internal air pressure. The bubble is then sized and air cooled with an air ring, internal bubble cooling and a sizing cage. The bubble is then collapsed in a nip thereby forming a double ply film that can be processed by Machine Direction Orientation (MDO) process. The film is then either slit separated and wound as two individual webs, or wound in double thickness without being separated.

In the casting of polymer films, polymers can be extruded through a die to form a melt curtain which is then rapidly quenched on a chill roll comprising an internally cooled roller or drum. The films can consist of one or more layers and can have a thickness of between 6 and 200 microns (0.24 to 7.9 mil, 1 mil=0.001 inches).

Various types of films can be manufactured from the aforementioned methods. One such film is a conventional stretch film that is used in hand (manual) or machine wrapping applications. The conventional stretch film is manufactured from specific materials (e.g., polyolefin polymers) with such characteristics and behavior that it can impart sufficient stretchability into the film so that the stretch film can be stretched as it is hand or machine wrapped around an object. For example, conventional stretch films can be used in bundling and packaging applications such as for securing bulky loads such as boxes, merchandise, produce, equipment, parts, and other similar items onto pallets.

The performance of the film to secure an object to a pallet (e.g., load retention performance) can be affected by the amount of stretch in the film, the strength of the film, the composition of the polymer, the number of wraps around the object and the strength of the edges of the film. Poor edge strength could result in tearing of the film during the wrapping process, particularly with high speed wrappers and thin films. Stretch films, particularly thin films at 10 micron and under, typically employ folded edges to increase the strength of the edge of the film. The films produced according to this process will be referred to herein as “conventional stretch films.”

Another type of film that can be manufactured from the aforementioned processes is a pre-stretch film. After processing, pre-stretch films are stiffer and thinner than conventional stretch film. The pre-stretch film is made by stretching or orientating a film beyond its yield point. The stretching can be accomplished in-process as the film is being produced or off-line after the film is wound onto one or more receiving rolls. However, the film material suitable for manufacturing pre-stretch film typically has a relatively lower viscosity and is a more stretchy (e.g., less stiff) compared to that of the polyolefin material used for conventional stretch films. The method of improving the stiffness properties of the films is referred to as the Machine Direction Orientation (MDO) process. In the MDO process, a film is stretched beyond its yield point (hot or cold) typically up to 300-400 percent, whereby its extendability (e.g. elastic stretchability) is greatly diminished. The film stretched in the MDO becomes stiffer and thinner and exhibits a greater load holding characteristic. Therefore, the pre-stretch film needs to be only minimally stretched (e.g., 20-40 percent, as compared with the conventional stretch film that requires up to 200 to 300 percent) during application to secure a load. During the stretching process in the MDO, the entire film decreases in thickness and decreases in width (i.e., neck-in process). However, due to the neck-in process the reduction in thickness of the film at the two free edges is not as pronounced as compared to remaining portions of the film between the free edges. As a result of the neck-in process that occurs during stretching, the free edges are naturally thicker than the remaining portions of the film. For example, the free edges of the film are typically 30-100 percent thicker than the rest of the film as a result of the neck-in, thereby strengthening the edge and eliminating the need for edge folding.

Cost reduction and environmental demands in recent years have resulted in a trend of thickness reduction for the hand (manual) as well as machine stretch films used in wrapping applications. It is more common to see stretch films under 17 microns down to 8 microns in those applications with thinner films comprising 3 to 35 layers (Nano films) but more typically (5 to 9 layers). Thinner films (12 micron and under) are typically made from lower melt index (higher viscosity) Polyolefin polymers to insure the production of stiffer and stronger stretch films to secure the wrapped product on the pallet. Thin films (e.g., 8-10 microns) are typically less stretchy than the prior art films having a conventional thickness of 20-25 micron. One side effect of thickness down gauging of those conventional stretch films, is that the edges of the film become fragile and more prone to damage (e.g., edge tearing) during handling as well as during the wrapping process. As shown in FIG. 1, in order to strengthen the edges 200 of a thin film 206 it is common to fold the edges 200 of the film to create a double thickness 2T of the film at both ends.

Another method to produce thinner stretch films is through producing thicker films (i.e., 17 to 25 micron) through an extrusion process (e.g., using cast or blown techniques) and then stretching the thicker films in an MDO prior to winding the thinner pre-stretch films having a thickness of about 6 to 10 micron. The film composition of those pre-stretch films are typically 3 to 5 layers of polyolefin resins with higher melt flow (e.g., 3-5 melt flow index) as compared with the lower melt flow resins (e.g., 1-3 melt flow index) used in making thin stiffer conventional stretch films as described herein. Melt flow index or MFI is a measure of the ease of flow of the melt of a thermoplastic polymer. It is defined as the mass of polymer, in grams, flowing in ten minutes through a capillary of a specific diameter and length by a pressure applied via prescribed alternative gravimetric weights for alternative prescribed temperatures. The method is described in standards ASTM D1238 and ISO 1133. Higher melt flow resins are typically easier to process than lower melt flow resins used in the manufacture of conventional stretch films and thus allow higher production speeds. As shown in FIG. 2A, a film 306 having a width W30 is fed to the stretching rollers 334A and 334B of the MDO 330. During the stretching process in the MDO 330, the film 306N necks-in and becomes narrower (i.e., width W32) than the width W30 prior to stretching. As the film 306N is stretched, the free edges 306E of the film 306N naturally remain thicker (e.g., a thickness T30E) than remaining portions of the film 306N which have a lesser thickness T30, due to the neck-in phenomenon as shown in FIG. 2B. The thickness of the free edges of the pre-stretch film typically increase to 30-100 percent of thickness of the rest of the film, thereby strengthening the free edge and eliminating the need for edge folding. The films produced according to this process (i.e., stretching via the MDO) will be referred to herein as “pre-stretch films.”

### SUMMARY

There is disclosed herein a device for producing film. The device includes a die defining a die outlet through which molten polymer is extruded. The device includes a film producing device (e.g., a rotatable casting drum or a film blowing device) spaced apart from the die. One or more coolant supplies are positioned proximate the film producing device for directing a stream of coolant onto the molten polymer positioned on the film producing device and/or between the die and film producing device, for producing film having strips of increased thickness.

There is also disclosed herein a method for producing film. The method includes providing a die having a die outlet and a film producing device spaced apart from the die outlet. A polymer is provided. The polymer is heated to a molten condition. The polymer is delivered to the die. The polymer is extruded through the die outlet onto the film producing device. A stream of coolant is directed onto a first portion of the polymer at a position on the film producing device and/or between the die and the film producing device. A film having strips of increased thickness at the first position is formed. The strips of increased thickness have a thickness which exceeds a base thickness of the film.

The film producing section can be, for example, a rotatable casting drum or a film blowing device.

In one embodiment, the polymer is suitable for producing conventional stretch film.

In one embodiment, the film is produced off-line. For example, a film receiving section is positioned downstream of the film producing device for receiving the film having strips of increased thickness, directly from the film producing section.

### BRIEF DESCRIPTION OF THE DRAWINGS

FIG. 1 is a schematic illustration of a section of film with folded edges;

FIG. 2A is a schematic illustration of a section of film with thickened edges formed via a neck-in process during stretching;

FIG. 2B is a cross sectional view of the film of FIG. 2A taken across line 2B-2B;

FIG. 3 is a schematic diagram of a stretch film processing apparatus of the present invention;

FIG. 4A is a schematic cross sectional view of a die and casting drum of the film processing apparatus of FIG. 3;

FIG. 4B is another embodiment of the die and casting drum of the film processing apparatus of FIG. 3, showing the coolant applied to the molten film at a different angle and also including a coolant recirculation system;

FIG. 4C is a schematic cross sectional view of a die and casting drum of the pre-stretch film processing apparatus of FIG. 3 showing a coolant being applied at multiple points of impingement;

FIG. 5A is a front view of the die and casting drum of FIG. 4A;

FIG. 5B is another embodiment of the die and casting drum of FIG. 5A wherein the film from the die exit already includes thickened strips and the thickened strips are cooled with a coolant;

FIG. 5C is a schematic front view of the die and casting drum of FIG. 4C showing a first coolant impinging the molten polymer between the die outlet and the casting drum and second coolant impinging the molten polymer on the casting drum;

FIG. 6A is an enlarged partial cross sectional view of a portion of the pre-stretch film processing apparatus of FIG. 4A, showing a coolant impinging the film at right angle;

FIG. 6B is an enlarged partial cross sectional view of a portion of the pre-stretch film processing apparatus of FIG. 4A, showing the coolant impinging the film at an acute angle;

FIG. 7A is a perspective view of film producing device for making rolls of conventional or pre-stretch film having strips of increased thickness;

FIG. 7B is a perspective view of a portion of an off-line pre-stretch system having an unwinder, a stretch section and a winder to wind pre-stretch film having strips on increased thickness;

FIG. 8A is a schematic illustration of localized increases in die gap at the die exit using multiple die bolts in the flexible die jaw to locally increase the die gap to create strips of increased thickness at those locations;

FIG. 8B is a schematic cross sectional view of a die lip with grooves permanently formed therein;

FIG. 9 is a cross sectional view of a surface of a cooling drum having grooves therein for forming strips of increased thickness.

FIG. 10 is a cross sectional view of the film of FIG. 7B taken across line 10-10;

FIG. 11A illustrates another embodiment of a die for producing strips of increased thickness via adding strips of same or similar polymer at predetermined intervals into the main molten film flow inside the die prior to exiting the die;

FIG. 11B is a cross sectional view of the die of FIG. 11A taken across line 12B-12B;

FIG. 11C is a top perspective view of the die of FIG. 11A with the flexible jaw removed;

FIG. 11D is a graph of molten polymer flow rate on a Y axis as a function of distance on an X axis taken in a direction parallel to the die lip;

FIG. 12 illustrates another embodiment of a die including heat exchangers for producing strips of increased thickness via locally heating and/or cooling the molten film inside the die prior to exiting the die to locally increase or decrease flow of molten polymer from the die.

### DETAILED DESCRIPTION

As shown in FIG. 3, a device for producing film is generally designated by the numeral 10. The device 10 includes a film delivery section 20. The film processing apparatus 10 includes a film receiving section 40 positioned directly downstream of the film delivery section 20.

As shown in FIG. 3, the film delivery section 20 includes a film production device, for example a casting device including a material feeder 21, such as a die which discharges molten material 6M from an outlet 21A thereof onto a casting drum 22. The outlet 21A of the die 21 is spaced apart from the drum 22 by a distance DD. In one embodiment, the distance DD is about 0.25 to 5.0 inches (6 to 130 mm). The die gap G is a generally linear opening in the die of about 1 mm as indicated by the letter G. The die gap G is typically adjustable by means of die bolts DB (see FIG. 4A) proximate the exit of die 21 to reduce the die opening of 1 mm down to 0.80 to 0.25 mm for the purpose of producing different film thickness out of the die gap. Reducing the die gap reduces the thickness of the film. In one embodiment, the material is a polymer having a suitable melt flow, viscosity and composition for making conventional stretch film or a pre-stretch film.

Referring to FIG. 3, the film delivery section 20 includes the rotatable drum 22 which defines an exterior surface 22E and which is configured to rotate about an axis 22A, for example, in the direction indicated by the arrow R1. The molten material 6M is transferred to the exterior surface 22E of the drum 22 via the outlet 21A while the drum is rotating. The drum 22 is maintained at a constant temperature for cooling and solidifying the molten material 6M to produce a thin film 6 thereon. Such constant cooling temperature of the cooling drum can be increased or decreased by means of the temperature control system of the cooling drum to suit the process of the film manufacturing. In one embodiment, the drum is a heat sink which cools and solidifies the molten material 6M. The film 6 is stretchable below its yield point, however it can be permanently deformed and stretched at or above its yield point.

As shown in FIGS. 4A and 5A, the film delivery section 20 includes a coolant supply 80 (e.g., a tank or vessel) containing a suitable coolant 88. A plurality of conduits 82 extend from the coolant supply vessel 80 and terminate at separate coolant discharge outlets 84 and 84′. As best shown in FIG. 5A, each pair of the coolant discharge outlets 84 and 84′ are aligned along a common arcuate path as shown by the arrow J. In one embodiment, the coolant discharge outlets 84 and 84′ are nozzles. The coolant discharge outlets 84 and 84′ are positioned between the die outlet 21A and the exterior surface 22E of the drum 22. The coolant discharge outlets 84 and 84′ are spaced apart from the molten material 6M by a horizontally adjustable distance D1 as shown in FIG. 4A. The coolant discharge outlets 84 and 84′ are spaced laterally apart from one another by laterally adjustable distance D2 as shown in FIG. 5A. A stream of the coolant 88 is discharged from each of the coolant discharge outlets 84 and 84′ so that the stream impinges on (at a point of impingement P for 84 and P′ for 84′) and accelerates a rate of cooling and solidification of a localized strip 6T of the molten material 6M, as compared to remaining portions of the molten material 6M which cool and solidify at a lesser rate. Similarly, a stream of the coolant 88 is discharged from each of the coolant discharge outlets 84′ so that the stream impinges on (at a point of impingement P′) and accelerates a rate of cooling and solidification of a localized strip 6T of the molten material 6M, as compared to remaining portions of the molten material 6M which cool and solidify at a lesser rate. As shown in FIG. 5A the strip has a width W1 and the film has an overall width of W2. The coolant 88 is shown impinging the molten material 6M at an angle β of about 90 degrees, as shown in FIG. 6A. However, as shown in FIGS. 4B and 6B, other angles of impingement may be employed such as but not limited to an acute angle β′ of 10 degrees or less especially when a liquid is used as a coolant to avoid marking of the film. The coolant 88 can be discharged from the coolant discharge outlets 84 and 84′ of the coolant supply vessel 80 at a constant rate or pulsed at a variable rate.

As shown in FIGS. 4C and 5C a film delivery section 120 is similar to the film delivery section 20 of FIGS. 4A, 4B, 5A and 5B except that there are two sets of conduits 82 and 182′ communicating with the coolant supply 80. The conduits 82 are configured to supply coolant 88 to the molten film 6M between the outlet 21A of the die 21 and the drum 22, as described herein with reference to FIGS. 4A, 4B, 5A, 5B, 6A and 6B. The conduits 182′ are configured to supply the coolant 88 to the molten film 6M while the molten film 6M is positioned on the drum 22. The plurality of conduits 182′ extend from the coolant supply vessel 80 and terminate at separate coolant discharge outlets 184 and 184′. As best shown in FIG. 5C, each pair of the coolant discharge outlets 184 and 184′ are aligned along a common arcuate path as shown by the arrow J. In one embodiment, the coolant discharge outlets 184 and 184′ are nozzles. The coolant discharge outlets 184 and 184′ are positioned over the drum 22. The coolant discharge outlets 184 and 184′ are spaced apart from the molten material 6M by an adjustable distance D1′ as shown in FIG. 4C. The coolant discharge outlets 184 are spaced laterally apart from one another by laterally adjustable distance D2 as shown in FIG. 5C. The coolant discharge outlets 184′ are spaced laterally apart from one another by laterally adjustable distance D2 as shown in FIG. 5C As shown in FIGS. 4C and 5C streams of the coolant 88 are discharged from each of the coolant discharge outlets 84 so that the stream impinges on (at a point of impingement P′) and accelerates a rate of cooling and solidification of a localized strip 6T of the molten material 6M, as compared to remaining portions of the molten material 6M which cool and solidify at a lesser rate.

While coolant discharge outlets 84 and 84′ are described and shown as being spaced apart from the molten material 6M by a distance D1, the present invention is not limited in this regard as the distance D1 can be variable. While the coolant discharge outlets 84 and 84′ are shown and described as being spaced laterally apart from one another by a distance D2, the present invention is not limited in this regard as the distance D2 may be variable.

Any suitable coolant 88 can be used including but not limited to a chilled gas and/or a chilled liquid. In one embodiment the chilled gas includes air. In one embodiment the chilled gas includes nitrogen. In one embodiment the chilled liquid includes water. In one embodiment the coolant 88 is an aerosol. In one embodiment the coolant 88 is a mist of a liquid and a gas.

As shown in FIG. 6A, the molten material 6M is discharged from the outlet 21A of the die 21. The molten material 6M decreases in thickness as it is pulled onto the drum 22. For example, the molten material 6M has a thickness T₁ at a point between the outlet 21A of the die 21 and a point P of impingement of the stream of coolant 88. At the point P of impingement the molten material 6M has a thickness T₂ which is less than T₁. At a point between the point P of impingement and the drum 22 a portion of the molten material 6M solidifies along the strip 6T. The strip 6T decreases in thickness at a lesser rate than the remaining portions of the molten material 6M. Thus, at the point between the point P of impingement and the drum 22 the molten material has a thickness TF₃, whereas the strip 6T has a greater thickness TT₃. When the molten material 6M engages the exterior surface 22E of the drum 22, solidification gradually progresses until the molten material 6M is fully solidified at a freeze line F on the drum 22. Prior to the freeze line F the molten material 6M has a thickness TF₄ and the strip 6T has a thickness TT₄. As shown in FIGS. 6A and 6B, the molten material 6M and the strip 6T each become progressively thinner between the point of impingement P and after the molten material 6M engages the drum 22. In particular, the thickness of the molten material decreases from TF₃ to TF₄ and the thickness of the strip 6T decreases from TT₃ to TT₄. While on the drum 22, the molten material 6M and the strip 6T continue to become thinner due to stretching and contraction due to cooling. In particular, the thickness of the molten material decreases from TF₄ to TF₅ and the thickness of the strip 6T decreases from TT₄ to TT₅. The localized cooling of the strip 6T causes the strip 6T to be of an increased thickness compared to the remaining portions of the film 6.

Referring to FIG. 4B, when a liquid is employed for the coolant 88, after the coolant 88 impinges the molten material at the point of impingement P at the acute angle β′, the coolant 88 drips along the strip 6T as indicated by the arrows M. At a bottom B of the drum 22 the coolant 88 drips off the drum in a stream and/or droplets 88P. A collection bin 89 is positioned under the drum 22 for collection of the stream and/or droplets 88P. A return line 83 is in communication with the collection bin 89 to convey the coolant away from the collection bin 89. A pump 85 is positioned in the return line 83 for pumping the coolant 88 to a heat exchanger 87 positioned downstream of the pump 85. The heat exchanger 87 includes an inlet 87A and an outlet 87B for conveying another coolant medium (e.g., chilled water from a cooling tower or a chiller) for cooling the coolant 88. The heat exchanger 87 is in communication with the coolant supply 80 for replenishing coolant 88 therein.

As shown in FIG. 3, the film delivery section 20 includes one or more delivery rollers 23, for example two idler rollers 23A and 23B over which the film 6, with the strips 6T having increased thickness relative to the remainder of the film 6, is discharged from the delivery section 20 in the general direction of arrows F1 and F2 to the film stretching section 30, the film 6 and the thickened film strips 6T are pulled off of the drum 22. The use of the thickened edges 6T1 and 6T2 allows for a greater strengthening of the film 6 and eliminates the need for edge folding.

While creating the strip 6T of an increased thickness is described herein as being accomplished by localized cooling of the film 6 as shown and described with reference to FIGS. 4A, 4B, 4C, 5A, 5B, 5C, 6A and 6B, the present invention is not limited in this regard as the thickness of the strip may be increased by other methods including but not limited to: 1) as shown in FIG. 8A, selectively adjusting the magnitude of the die gap G via actuation of the die bolts DB to deform a die lip 21L at localized portions 21G of the die 21 to increase the flow of molten material 6M from the die 21 to form precursor thickened strips 6T″ prior to the point of impingement P (FIG. 5B); 2) forming grooves 20G in a surface 22E of a cooling drum 22 (FIG. 9); 3) forming grooves 121G and/or 121G′ in a flexible jaw 121Z or a fixed jaw 121J at the die lip 121L (FIG. 8B); and 4) locally increasing the flow rate of molten polymer exiting the die lip 221L as described herein with reference to FIGS. 11A, 11B, 11C, 11D and 12.

Referring to FIG. 8A, the die 21 has the fixed jaw 21J and the flexible jaw 21K which is spaced apart from the fixed jaw 21J, thereby defining the die gap G at the die lip 21L. The flexible jaw 21K includes a head portion 21Y which is moveably secured to a base portion 21Z by a flexible hinge 21H. A plurality of die bolts DB extend between and are secured to the head portion 21Y and the base portion 21X. For example, one end of the die bolt DB is threaded into the head portion 21Y at a point 21X. Each of the die bolts DB is in communication with an actuator 21T to move the die bolt DB. In one embodiment, the actuator 21T is a heater element disposed inside the die bolt DB to extend and contract the length of the die bolt DB by thermal expansion and contraction. Movement of the die bolt DB causes localized deformation in the head portion 21Y which creates a depression or groove 21G in the head portion 21Y at the die lip 21L in alignment with the die bolt DB. For illustration, four die bolts DB and four depressions 21G are shown. However, the present invention is not limited in this regard as any number of die bolts DB and depressions 21G at any spacing may be employed. A molten polymer 6M is extruded through the die lip 21L with strips of increased thickness 6T″ as shown in FIG. 5B.

Referring to FIG. 8B a die 121 is similar to the die 21 of FIG. 8A except that the die 121 includes permanent grooves 121G cut or formed into the flexible jaw 121Z at the die lip 121L. In one embodiment, the die 121 includes permanent grooves 121G′ formed in the fixed jaw 121J at the die lip 121L.

As shown in FIGS. 11A, 11B and 11C, the die 221 includes a main manifold 269A that extends longitudinally (along axis X) across the die 221 for discharging the molten material 6M therefrom. The die 221 also includes a plurality of second manifolds 269B that are spaced apart from one another in the longitudinal direction parallel to the axis X for discharging molten material 6M′ therefrom. The die 221 also includes a plurality of third manifolds 269C which are spaced apart from one another in the longitudinal direction parallel to the axis X for discharging molten material 6M″ therefrom. In one embodiment, the molten material 6M′ and/or 6M″ is of the same composition and has the same properties of the molten material 6M. In one embodiment, the molten material 6M has a different composition and has different properties of the molten material 6M′ and/or 6M″. The molten material 6M′ is provided at a flow rate through the manifolds 269B added to a flow rate of the molten material 6M through the manifold 269A, sufficient to cause a localized thickening of the combined molten material exiting the die lip 221L. While the molten material 6M′ is described as being provided at a flow rate through the manifolds 269B, the present invention is not limited in this regard as the flow rate of the molten film 6M′ may be adjusted a different flow rates for different manifolds or may be varied with time. The molten material 6M″ is provided at a flow rate through the manifolds 269C added to a flow rate of the molten material 6M through the manifold 269A, sufficient to cause a localized thickening of the combined molten material exiting the die lip 221L. In one embodiment, the combined molten material exiting the die lip 221L includes the molten material 6M, 6M′ and/or 6M″.

With reference to FIG. 11D, a graph illustrates flow rate of the molten polymer on a Y1 axis, thickness of the molten material exiting the die lip 221L on a second Y2 axis and position of the manifolds 269A and 269B on the X axis. The flow rate of the molten material 6M is shown as being a constant F1 along the X axis. The flow rate of the molten material 6M′ from one of the manifolds 269B is shown having a flow rate F3 minus F1 and the flow rate from two of the manifolds 269B is shown as being F2 minus F1 which is less than F3. A total flow rate exiting the die lip 221 between the manifolds 269B is F1 resulting in a thickness of TF10. A total flow rate exiting the die lip 221 at one of the manifolds 269B is F2 resulting in a thickness of TT10′. In one embodiment, the molten material 6M″ further adds a flow rate F4 to the flow rate exiting the die lip and to the thickness of the strips of increased thickness 6T″.

Referring to FIG. 12 a die 221 is similar to the die 21 of FIG. 8A except that the die 221 includes a plurality of heat exchangers 299 and 299′ disposed in the fixed jaw 221J proximate the die lip 221L. In one embodiment, the die 221 includes plurality of heat exchangers 299 and 299′ disposed in the flexible jaw 221Z proximate the die lip 121L. The heat exchangers 299 and 299′ are spaced apart from one another. The heat exchangers 299 extend a length L99 along the X axis and the heat exchangers 299′ extend a length L99′ along the X axis. The heat exchangers 299 and 299′ are configured to heat a portion of the fixed jaw 221J and/or a portion of the flexible jaw 221Z adjacent to the die lip 221L to locally and/or selectively heat the molten polymer 6M. The inventors have discovered that heating the molten polymer 6M locally and/or selectively causes local and selective increases in flow rate of the molten polymer 6M to create thickened strips of the molten polymer exiting the die lip 221L. Conversely, local and/or selective cooling of the molten polymer 6M causes a decrease in flow thereof and thinner strips of the molten polymer 6M exiting the die lip 221L.

Referring back to FIG. 3, the film receiving section 40 includes two idler rollers 41A and 41B over which the film 6 sections travels as the idler rollers 41A and 41B rotate. The film receiving section 40 includes a winding apparatus, for example, a drum 42 rotatably mounted about an axis 42A for winding the film with strips of increased thickness 6P thereon. The film 6P is fed onto the drum 42 and is wound.

Referring to FIG. 7A, a device for producing film 10 includes a film producing section 20 including a die 21 and a casting drum 22 upon which the film 6 having strips 6T on increased thickness is formed and cooled. The film 6 is fed into the film receiving section 40 which includes a winding roll 42. The winding roll 42 is removable from the film receiving section for use in an off-line process for machine direction stretching as described herein with reference to FIG. 7B. In one embodiment, the winding roll 42 is removed and used in another off-line process for producing smaller rolls (e.g., smaller diameter and/or width), with or without machine direction stretching.

Referring to FIG. 7B, a device 110 for producing pre-stretch film via off-line machine direction stretching. The device 110 includes an unwinder section 160 which includes the winding roll 42, having the film 6 with the strips of increased thickness 6T thereon, that has been removed from the film receiving section 40 of FIG. 7A. The device includes slitting devices 33 that slit the film 6 through the strips of increased thickness 6T, before stretching. The device 110 includes a stretching section 130 having stretching rollers 34A and 34E. The slit pre-stretch film 6 is wound into separate rolls 42A′, 42B′, 42C′ and 42D′ of pre-stretch film. While four rolls are shown, the present invention is not limited in this regard as the film may be wound onto one or more rolls.

Although the present invention has been disclosed and described with reference to certain embodiments thereof, it should be noted that other variations and modifications may be made, and it is intended that the following claims cover the variations and modifications within the true scope of the invention.

What is claimed is:

1. A device for producing film, the device comprising:
a die defining a die outlet through which molten polymer is extruded, the polymer being suitable for producing one of a pre-stretch film and a conventional stretch film;
a film producing device spaced apart from the die; and
at least one coolant supply positioned proximate the film producing device for directing a stream of coolant onto the molten polymer positioned on at least one of:
the film producing device, and
between the die and film producing device, for producing film having strips of increased thickness.

2. The device of claim 1, wherein the coolant comprises a chilled gas.

3. The device of claim 2, wherein the chilled gas comprises air.

4. The device of claim 2, wherein the chilled gas comprises nitrogen.

5. The device of claim 1, wherein the coolant comprises a chilled liquid.

6. The device of claim 5, wherein the chilled liquid comprises water.

7. The device of claim 1, wherein the coolant comprises an aerosol.

8. The device of claim 1, wherein the film producing device is a rotatable casting drum.

9. The device of claim 1, wherein the film producing device is a film blowing device.

10. The device of claim 1, further comprising a film receiving section positioned downstream of the film producing device for receiving, directly from the film producing section, the film having strips of increased thickness, the film having strips of increased thickness being configured for use in an off-line pre-stretch film producing device.

11. The device of claim 1, further comprising:
at least one device for selectively and locally controlling a flow rate of the molten polymer to create the strips of increased thickness.

12. A method for producing film, the method comprising:
providing a die having a die outlet and a film producing device spaced apart from the die outlet;
providing a polymer;
heating the polymer to a molten condition;
delivering the polymer to the die;
extruding the polymer through the die outlet onto the film producing device;
directing a stream of coolant onto a first portion of the polymer at a position on at least one of:
the film producing device, and
between the die and the film producing device; and
forming a film with strips of increased thickness along the first portion of the polymer, the strips of increased thickness having a thickness that exceeds a base thickness of the film.

13. The method of claim 12, wherein the film producing device comprises a rotatable casting drum.

14. The method of claim 12, wherein the film producing device comprises a blown film device.

15. The method of claim 12, wherein the coolant comprises a chilled gas.

16. The method of claim 15, wherein the chilled gas comprises air.

17. The method of claim 15, wherein the chilled gas comprises nitrogen.

18. The method of claim 12, wherein the coolant comprises a chilled liquid.

19. The method of claim 18, wherein the chilled liquid comprises water.

20. The method of claim 12, wherein the coolant comprises an aerosol.

21. The method of claim 12, further comprising:
providing a film receiving section positioned downstream of the film producing device; and
transferring the film to the film receiving section directly from the film producing section for use in an off-line pre-stretch film producing device.

22. The method of claim 12, further comprising selectively and locally controlling flow rate of the molten polymer exiting the die outlet to create the strips of increased thickness.
